(19) United States
(12) Patent Application Publication
(10) Pub. No.: US 2006/0017401 A1
(43) Pub. Date: Jan. 26, 2006

(54) Dimming control techniques using self-excited gate circuits

(76) Inventors: Shu-Yuen Ron Hui, Shatin (HK); Shu-Hung Henry Chung, Hong Kong (HK)

Correspondence Address: BARNES & THORNBURG, 11 SOUTH MERIDIAN, INDIANAPOLIS, IN, 46204, US

(21) Appl. No.: 11/221,218

(22) Filed: Sep. 7, 2005

Related U.S. Application Data
(63) Continuation of application No. 10/667,571, filed on Sep. 22, 2003, now abandoned.

(51) Int. Cl. H05B 41/16

(52) U.S. Cl. 315/274

(57) ABSTRACT

There is described methods and techniques for providing dimming control of low-cost fluorescent lamps that are driven by self-excited gate circuits and which are nominally non-dimmable. A dimming function is achieved by providing a variable DC voltage input to the ballast. It is possible to retroactively change existing non-dimmable lamps into dimmable lamps, or to form new low-cost dimmable fluorescent lamps.

### FIELD OF THE INVENTION

This invention relates to apparatus for providing dimming control of a low-cost fluorescent lamp, and in particular for dimming a fluorescent lamp drive by a self-excited gate circuit. The invention extends to the retroactive conversion of non-dimmable lamps to dimmable lamps, and to new designs for low cost fluorescent dimmable lamps.

### BACKGROUND OF THE INVENTION AND PRIOR ART

Self-excited gate/base circuits have been proposed and commonly used as a low-cost solution for driving the totem pole switches in power converters, particularly in non-dimmable electronic ballast applications. Based on the low-cost analog self-oscillatory circuits, the complementary switching signals can be generated without using integrated circuit for the two power electronic switches. Traditionally, non-dimmable electronic ballasts using self-excited gate/base drive circuits are powered by nominally constant DC voltage source or DC voltage with only limited fluctuation.

FIG. 1 shows the schematic of a typical ‘low-cost’ non-dimmable electronic ballast for linear and compact fluorescent lamps. It consists of (i) an input electromagnetic interference (EMI) filter, (ii) an AC-DC power conversion stage which, for low power application (<25 W typically), can usually be a diode rectifier followed by an output bulk capacitor, and (iii) an half-bridge power inverter circuit loaded with a discharge lamp. For higher power applications (higher than 25 W typically), the second AC-DC power stage can also be a valley-fill and/or charge-pump circuit that provides power factor correction [8,9]. In some cases, the second stage and the inverter are ‘integrated’ together in order to form a so called single-stage power circuit.

The DC link voltage that feeds the half-bridge inverter is nominally constant with some voltage fluctuation or has a limited voltage variation if a valley-filled type circuit is used in the passive AC-DC power conversion stage for power factor correction.

For low-cost applications, self-excited gate/base drive circuits have commonly been used in non-dimmable electronic ballasts because the elimination of integrated-circuits for gate/base drives can reduce the cost of the ballast significantly. FIG. 2 shows a schematic of a non-dimmable self-excited base drive circuit for an electronic ballast driving a fluorescent lamp. This design is the most commonly used design in low-cost non-dimmable electronic ballasts for linear and compact fluorescent lamps.

The operational details of this self-excited circuit are well-known and can be briefly summarized here. C1 is a DC stabilizing capacitor for reducing the DC voltage ripple. C4 is a DC blocking capacitor to eliminate the DC voltage component in the resonant tank consisting of L1 and C5. The self-excited base drive circuits consist of a transformer that comprises two secondary windings T1 and T2. T1 and T2 are magnetically coupled with a primary winding that is connected in series with the resonant inductor L1, and they are connected in opposite polarity in their respective base drive circuits that consist of a resistor (R3 for switch Q1 and R4 for switch Q2) and a diode (D5 for Q1 and D6 for Q2). Power diodes D3 and D4 are the freewheeling diodes for power switches Q1 and Q2, respectively.

When a DC voltage is applied across C1, the capacitor C2 will be charged through R1. When the DC voltage across C2 reaches a breakdown voltage of the diac D2 (typically 32V), the diac D2 will be turned on and current will flow through R1 into the base of Q2 and consequently Q2 is turned on. The DC link voltage will then be applied to the resonant tank loaded with the discharge lamp. When the current is increasingly flowing into dotted end of the primary winding of the transformer through the resonant tank, a back electromotive force is developed in the winding that resists the inflow current. Consequently, a voltage is induced in T2 to assist the bottom power switch Q2 to remain conducting and a voltage is induced in T1 (of an opposite polarity with respect to T2) to keep Q1 off. Due to the resonant tank operation, the current will follow an approximate sinusoidal waveshape. When the current starts to decrease, i.e. with a negative rate of change of current di/dt, the voltage developed in the transformer primary winding will be reversed and hence the voltages in T1 and T2 are reversed too, resulting in Q2 being turned off and Q1 turned on.

The resonant current in the transformer primary winding therefore induces complimentary voltages in T1 and T2 to switch at appropriate times at a frequency determined by the loaded resonant tank frequency. This self-excited base drive operation does not require any integrated circuit and is thus a low-cost solution. It must be stressed that the operating frequency of this self-excited circuit is determined by the loaded resonant tank. The operating frequency of the resonant tank will only shift slightly according to the load condition. Therefore, self-excited base/gate drive circuit does not allow the half-bridge inverter to change its operating frequency substantially for dimming purposes and is traditionally used for non-dimming ballasts only. In addition, self-excited circuits are usually designed for a DC link voltage with a limited variation and cannot be operated over a very wide DC voltage range.

It should also be noted that traditionally dimming of a lamp controlled by an ballast is achieved by frequency control. Typically the operating frequency of the half-bridge inverter is changed from 1 per unit to about 2 per unit in order to dim the discharge lamp from 100% to about 10%. Dimming control for electronic lighting systems based on DC link voltage control has been proposed by the applicants in U.S. Pat. No. 6,486,615. This DC link voltage-control dimming approach has better energy efficiency and less EMI emission than frequency dimming control. An electronic ballast with emphasis on dc link voltage control has been mentioned in U.S. Pat. No. 5,416,386 in which a step-up or boost-type power converter is used as a pre-converter. However, in U.S. Pat. No. 5,416,386 the DC link voltage must be higher than the peak value of the input ac voltage. So the DC link voltage must be higher 1.41 times the rms value of the input voltage (i.e. higher than 310V for a 220V as mains) and cannot be used for dimming purpose.

In some electronic lighting applications such as desk/table/floor lamps, a dimming function is often unavailable especially when energy-saving non-dimmable compact fluorescent lamps are used. An object of the present invention, at least in its preferred forms, is to provide a means whereby conventionally non-dimmable lighting installations such as desk/table/floor lamps can be easily modified into dimmable ones, even if standard products of non-dimmable ballasts for linear and compact fluorescent lamps are used. For example, with the proposed method, a dimming feature can be incorporated into a desk lamp that uses a commonly available non-dimmable compact fluorescent lamp. The dimmable feature allows consumers to dim ‘non-dimmable’ compact fluorescent lamp products.

### SUMMARY OF THE INVENTION

According to the present invention there is provided a dimmable lighting system comprising a fluorescent lamp driven by an electronic ballast comprising a self-excited drive circuit, and means for providing a variable DC voltage as an output, said variable DC voltage being the input to said ballast.

Preferably the means for providing a variable DC voltage comprises an AC-DC power converter connected between an AC mains and the ballast. This converter may be a step-up/down flyback converter, or a step-down forward converter, or any other suitable converter capable of providing a varying DC voltage. The converter may also be a power factor corrected AC-DC converter.

In a preferred embodiment the means for providing a variable DC voltage comprises an AC-DC converter connected to an AC mains supply, followed by a DC-DC power converter providing the variable DC voltage as an output to said ballast. In some cases the Ac-Dc and DC-DC converters may be integrated into a single-stage converter. This is particularly suitable when the system has multiple lamps in parallel, and preferably the AC-DC converter is a power factor corrected converter.

In some embodiments the means for providing a variable DC voltage is provided separately from said ballast and said lamp, and is provided with connection means enabling the means for providing a variable DC voltage to be connected between an AC mains supply and said lamp. In this embodiment it is possible for conventional non-dimmable lamps to be converted into dimmable lamps by simply inserting a module including the means for providing the variable DC voltage between the AC mains and the lamp. This module would be provided with a suitable connection (eg screwthread or bayonet) that enabled it to be connected into a lamp socket connected to the mains, and would be provided with a corresponding connection that allowed a lamp to be connected to the module. Alternatively of course the means for providing a variable DC voltage may be formed integrally with said ballast.

Viewed from another broad aspect the present invention provides apparatus for enabling dimming control of a nominally non-dimmable lamp comprising, means for providing a variable DC voltage, said means for providing a variable DC voltage having connection means that enables said means for providing a variable DC voltage to be located between a lamp fitting and a said lamp.

Viewed from a further broad aspect the invention also provides a method for providing dimming control of a nominally non-dimmable lamp driven by an electronic ballast comprising a self-excited drive circuit, comprising providing a variable DC voltage as an input to said ballast.

Viewed from a yet further broad aspect the invention also provides a method of converting a nominally non-dimmable lamp into a dimmable lamp comprising connecting to an AC mains supply a module capable of providing a variable DC voltage, and connecting said lamp to said module whereby said variable DC voltage is provided as the input to said lamp.

### BRIEF DESCRIPTION OF THE DRAWINGS

Some embodiments of the invention will now be described by way of example and with reference to the accompanying drawings, in which:-

FIG. 1 is a schematic illustrating a conventional low-cost non-dimmable electronic ballast,

FIG. 2 shows a typical circuit for a conventional ballast as shown in FIG. 1,

FIG. 3 is a schematic illustrating an embodiment of the present invention,

FIG. 4 shows an example of an AC-DC converter that may be used in an embodiment of the invention,

FIG. 5 shows another example of an AC-DC converter that may be used in an embodiment of the invention,

FIG. 6 shows an embodiment of the present invention as applied to multiple lighting loads,

FIG. 7 shows an embodiment of the invention employing mains frequency rectangular voltage output with voltage magnitude control,

FIG. 8 illustrates the characteristics of an LC resonant circuit loaded with a resistor,

FIG. 9 plots the variation of self-oscillatory frequency as a function of DC link voltage in an example of the invention, and

FIG. 10 plots the variation in brightness of a nominally non-dimmable lamp as a function of DC link voltage in an example of the invention.

### DETAILED DESCRIPTION OF PREFERRED EMBODIMENTS

As will be seen from the following description, the present invention at least in its preferred forms provides a simple dimming technique and a dimming module that can turn a nominally non-dimmable ballast system or product into a dimmable one. An AC-DC power converter, which can provide a variable output DC voltage over a wide voltage range (typically 40V to 380V), is proposed as a dimming device. Examples of such AC-DC converters that may be used include a Step-up/down converter sometimes known as flyback converter. Another example which is more suitable for powering multiple lighting devices is a power electronic system comprising a power-factor-corrected AC-DC converter (that provides a nominally constant DC voltage) followed by a step-down power converter (that has a controllable DC output voltage within a range from typically 40V to 380V). When connected to a standard non-dimmable electronic ballast for a linear or compact fluorescent lamp, it can make the latter dimmable.

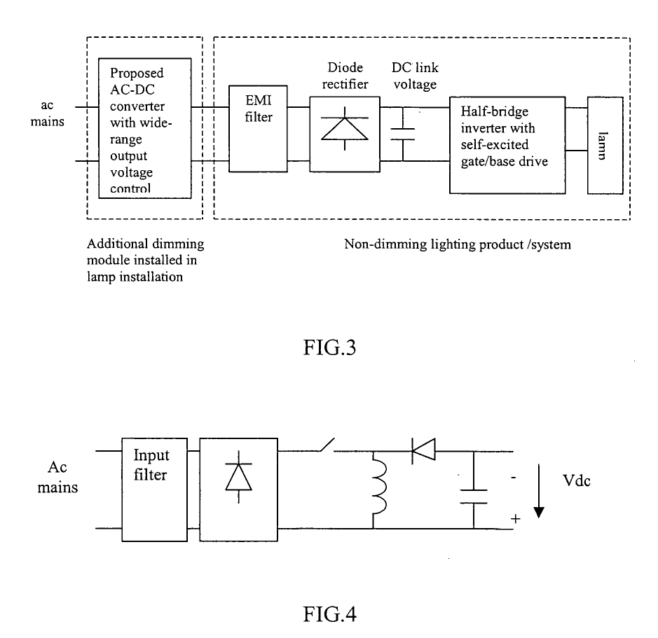

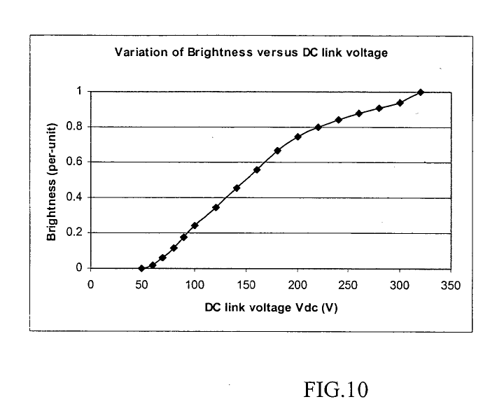

FIG. 3 to FIG. 6 show the proposed concept of using an AC-DC power converter with a wide controllable DC output voltage range (typically from 40V to 380V), such as a step up/down converter or a step-down converter, to make a non-dimmable ballast design dimmable. FIG. 7 shows an extended version of the concept to generate at mains frequency a controllable ac rectangular voltage for dimming a nominally non-dimmable lighting products. FIGS. 9 and 10 show experimental results.

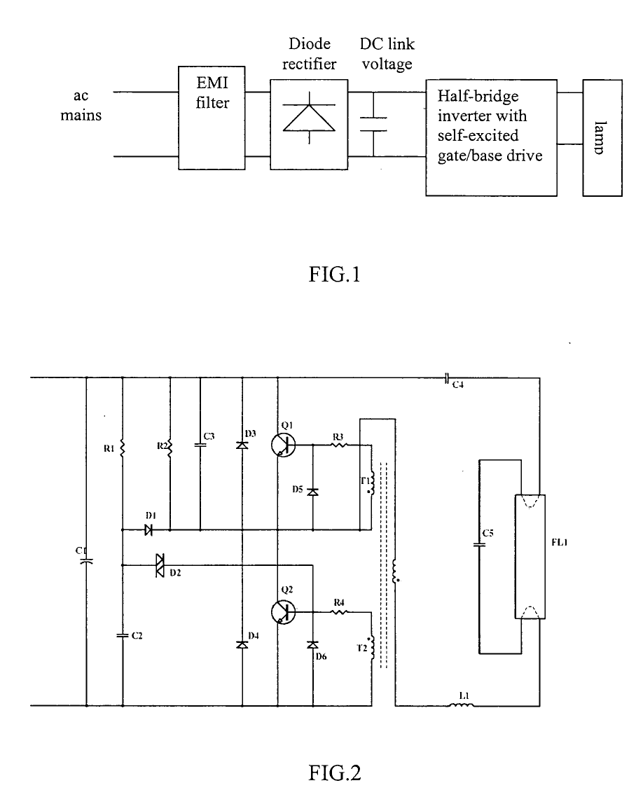

A schematic of conventional non-dimmable electronic lighting systems such as compact fluorescent lamps is shown in FIG. 1. This consists of a front-end AC-DC conversion stage such as a rectifier for providing a nominally constant DC voltage and an inverter that drives the lamp at high frequency. The non-dimmable product can be screwed into the lamp holder of a lighting installation (e.g. a desk lamp), but it cannot be dimmed. However, by using a dimming module according to an embodiment of the present invention between the ac mains and the lighting device with a variable DC voltage source provided by an AC-DC step-up/down converter in a lighting installation, the power converter provides a controllable DC voltage and thus a dimming function for the otherwise non-dimmable lighting device via the lamp connectors.

The variable DC voltage provided by the power converter will appear in the DC voltage link capacitor of the non-dimmable product through the EMI filter and the diode rectifier (FIG. 3). As long as the self-excited half-bridge inverter—the discharge lamp system functions normally at the controlled DC link voltage that may change within a certain range, dimming of the discharge lamp can be achieved.

An example of one possible AC-DC power converter is shown in FIG. 4 and in this example includes an input filter, a diode rectifier and a step-up/down or flyback converter. FIG. 5 shows a second example that includes an input filter, a diode rectifier with bulk capacitor and a step-down (forward) converter. Both examples can provide a variable DC output voltage over a wide voltage range. However, it should be understood that the AC-DC power converter is not restricted to these two examples and other forms of converter may be used.

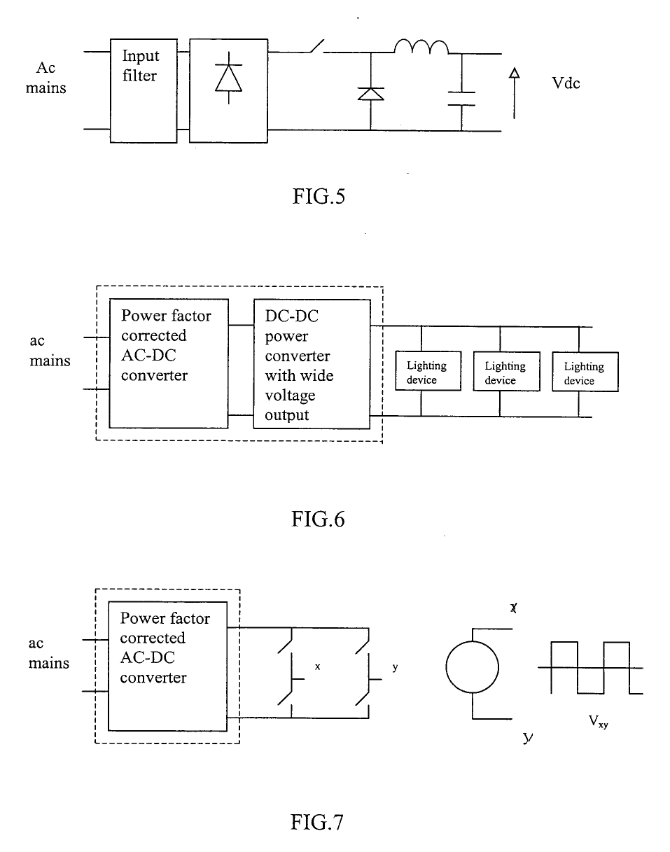

FIG. 6 shows an embodiment of the invention for multiple lighting devices. The variable DC voltage can be provided by a power electronic system comprising an AC-DC (preferably power-factor-corrected) power converter followed by a power step-down converter. This version is more suitable if a high-power application is required.

An important aspect of the present invention is that although a non-dimmable lighting device such as a compact fluorescent lamp is designed to be powered by the AC mains, it can also be powered by a variable DC voltage. That is, the front-end rectification stage of the non-dimmable lighting product will also provide a DC voltage link for the inverter circuit if the product is powered by a DC voltage source. Therefore, when the external DC voltage can be adjusted, the DC link voltage that powers the inverter circuit in the non-dimmable lighting device can also be adjusted. As long as the driving circuit of the inverter in the lighting system remains functional, the external DC voltage control allows the nominally non-dimmable lighting product/system to become dimmable.

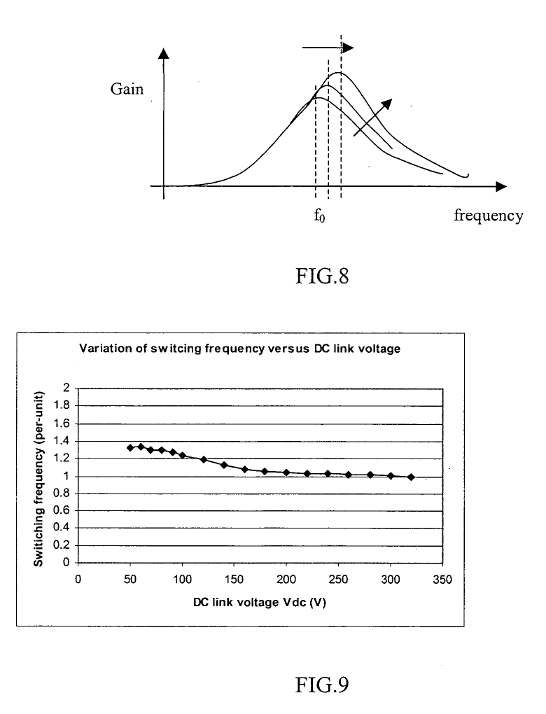

It should be noted that as the discharge lamp is dimmed, its lamp arc resistance increases. Most conventional low-cost electronic ballasts for discharge lamps use self-excited gate/base drive circuits in the ballast inverter. Because the inverter usually employs an inductor-capacitive resonant circuit to drive the lamp, the self-excited oscillatory frequency (i.e. the switching frequency of the inverter) is the loaded resonant frequency of the LC circuit. FIG. 8 shows the resonance characteristic of a resonant circuit loaded with a resistor. It should be noted that the self-oscillatory frequency will shift (increases) as the lamp is dimmed (lamp arc resistance increases).

Tests have been carried out to demonstrate the practicality and effectiveness of embodiments of the present invention. A ‘non-dimmable’ compact fluorescent lamp (OSRAM 20 W 1140 Lumen Daylight 3U 220V-240V 50 Hz/60 Hz—OSRAM DULUX) was connected to the DC voltage output of a dimming module according to an embodiment of the present invention (an AC-DC flyback converter was used in this case—FIG. 4).

FIG. 9 shows the measured variation of the switching frequency of the self-excited electronic ballast of this ‘non-dimmable’ compact fluorescent lamp fed by a DC voltage over a voltage range. FIG. 9 shows that the switching frequency of the self-excited ballast has only a small degree of variation. As explained above, as the fluorescent lamp is dimmed, its lamp arc resistance increases and the self-oscillatory frequency increases slightly. In this particular case, the variation of the switching frequency is less than 30% (of its base frequency of 40 kHz) within the dimming range.

FIG. 10 shows the dimming characteristic of the lamp, i.e. the variation of the brightness with the control dc voltage. It should be noted that, for conventional frequency-controlled dimmable electronic ballasts, the variation of the switching frequency is typically 100% (i.e. from 1.0 per-unit to 2.0 per-unit) for the full dimming range. The experimental results are clear evidence that in embodiments of the present invention the dimming function is mainly provided by the DC voltage control rather than the frequency variation.

If in an embodiment of the present invention an AC-DC converter with wide output voltage control is installed in a lighting installation and its controllable DC voltage is used as the power source in the connector terminals for the discharge lamps, nominally ‘non-dimmable’ electronic ballast-discharge lamp products can be connected to the connector terminals and the ‘non-dimmable’ products can become dimmable. Indeed, even if an incandescent lamp is connected to the terminals, it is still dimmable under a variable DC voltage control. Hence, if a lighting installation such as a desk lamp has an AC-DC step-up/down converter installed to provide a controllable voltage source for a lighting device, both non-dimmable compact fluorescent lamps and incandescent lamps can be screwed into the connector of the lamp holder and can be dimmed. If a ‘non-dimmable’ electronic ballast for a linear fluorescent lamp is powered by an external AC-DC step-up/down converter, the non-dimmable system can become dimmable based on the same principle. Multiple discharge lamps lighting systems can be powered by one system as shown in FIG. 6.

The above descriptions focus on cases where existing ‘non-dimmable’ electronic lighting systems are used with an externally connected AC-DC converter to form a dimmable system. However, the present invention is not restricted to using the AC-DC power converter with wide output voltage control as a separate module. Instead the AC-DC power converter can be integrated in a single ballast circuit as the front-end AC-DC power stage. The essence of this aspect of the invention is the combined used of voltage control and self-excited half-bridge inverter as demonstrated in FIGS. 9 and 10. By using an AC-DC power converter with wide-range voltage control to feed a self-excited ballast inverter (FIG. 2) as an integrated design (for example in a desk lamp product that uses a fluorescent lamp), a low-cost dimmable lighting system can be developed.

1. A dimmable lighting system comprising a fluorescent lamp driven by an electronic ballast comprising a self-excited drive circuit, and means for providing a variable DC voltage as an output, said variable DC voltage being the input to said ballast.

2. A system as claimed in claim 1 wherein said means for providing a variable DC voltage comprises an AC-DC power converter connected between an AC mains and said ballast.

3. A system as claimed in claim 2 wherein said power converter comprises a step-up/down flyback converter.

4. A system as claimed in claim 2 wherein said power converter comprises a step-down forward converter.

5. A system as claimed in claim 2 wherein said power converter is a power factor corrected AC-DC converter.

6. A system as claimed in claim 1 wherein said means for providing a variable DC voltage comprises an AC-DC converter connected to an AC mains supply, followed by a DC-DC power converter providing said variable DC voltage as an output to said ballast.

7. A system as claimed in claim 6 wherein said AC-DC converter is a power factor corrected converter.

8. A system as claimed in claim 6 comprising multiple lamps in parallel.

9. A system as claimed in claim 1 wherein said means for providing a variable DC voltage is provided separately from said ballast and said lamp, and wherein said means for providing a variable DC voltage is provided with connection means enabling said means for providing a variable DC voltage to be connected between an AC mains supply and said lamp.

10. A system as claimed in claim 1 wherein said means for providing a variable DC voltage is formed integrally with said ballast.

11. Apparatus for enabling dimming control of a nominally non-dimmable lamp comprising, means for providing a variable DC voltage, said means for providing a variable DC voltage having connection means that enables said means for providing a variable DC voltage to be located between a lamp fitting and a said lamp.

12. Apparatus as claimed in claim 11 wherein said means for providing a variable DC voltage comprises an AC-DC power converter.

13. Apparatus as claimed in claim 12 wherein said power converter comprises a step-up/down flyback converter.

14. Apparatus as claimed in claim 12 wherein said power converter comprises a step-down forward converter.

15. Apparatus as claimed in claim 12 wherein said power converter is a power factor corrected AC-DC converter.

16. Apparatus as claimed in claim 11 wherein said means for providing a variable DC voltage comprises an AC-DC converter followed by a DC-DC power converter providing said variable DC voltage as an output to said ballast.

17. Apparatus as claimed in claim 16 wherein said AC-DC converter is a power factor corrected converter.

18. A method for providing dimming control of a nominally non-dimmable lamp driven by an electronic ballast comprising a self-excited drive circuit, comprising providing a variable DC voltage as an input to said ballast.

19. A method as claimed in claim 18 wherein said variable DC voltage is obtained by providing an AC-DC power converter between an AC mains supply and said ballast.

20. A method as claimed in claim 18 wherein said power converter comprises a step-up/down flyback converter.

21. A method as claimed in claim 18 wherein said power converter comprises a step-down forward converter.

22. A method as claimed in claim 18 wherein said power converter is a power factor corrected AC-DC converter.

23. A method as claimed in claim 18 wherein said variable DC voltage is provided by an AC-DC converter connected to an AC mains supply, followed by a DC-DC power converter providing said variable DC voltage as an output to said ballast.

24. A method as claimed in claim 23 wherein said AC-DC converter is a power factor corrected converter.

25. A method as claimed in claim 18 wherein said variable DC voltage is provided by a separate module that is located between an AC mains supply and said ballast.

26. A method as claimed in claim 18 wherein said variable DC voltage is provided by a means formed integrally with said ballast.

27. A method of converting a nominally non-dimmable lamp into a dimmable lamp comprising connecting to an AC mains supply a module capable of providing a variable DC voltage, and connecting said lamp to said module whereby said variable DC voltage is provided as the input to said lamp.
